(19) United States
(12) Patent Application Publication
(10) Pub. No.: US 2009/0073478 A1
(43) Pub. Date: Mar. 19, 2009

(54) IMAGE FORMING APPARATUS

(75) Inventor: Noriyuki TAKUWA, Kawasaki-shi (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/207,060

(22) Filed: Sep. 9, 2008

Related U.S. Application Data
(60) Provisional application No. 60/972,740, filed on Sep. 14, 2007.

(51) Int. Cl. G06F 3/12

(52) U.S. Cl. 358/1.13

(57) ABSTRACT

According to an embodiment of the present invention, in an apparatus in which an operation panel is provided from a main body via a column, the column is located on a side of the main body and is hollow, and a harness from the main body is located in the column.

### CROSS-REFERENCE TO RELATED APPLICATION

This application is based upon and claims the benefit of U.S. Provisional Application No. 60/972,740 filed on Sep. 14, 2007, the entire contents of each of which are incorporated herein reference.

### TECHICAL FIELD

The present invention relates to an image forming apparatus that can obtain a copy image, i.e., an output and a printout, i.e., a hard copy of an object.

### BACKGROUND

As an image forming apparatus that can use general plain paper not specially processed as a recording material (a sheet material), image forming apparatuses employing various systems such as an electrophotographic system, an ink jet system, and a thermal transfer system are already widely spread. The image forming apparatuses are now referred to as multi-functional peripherals (MFP).

An MFP integrally includes many additional mechanisms (accessory devices) according to diversification of requests from users. One of the accessory devices is, for example, a stapler that staples two or more printouts using a staple. Another one of the accessory devices is a finisher that can hold a large number of copies (a predetermined number is treated as one unit) of printouts for each of the copies. Still another one of the accessory devices is an automatic document feeder (ADF) that replaces, when a scanning object (an original) is sheet-like, every time information representing the scanning object is scanned, the scanning object, the information of which is scanned, with the next scanning object.

The accessory devices are integrated with an MFP main body by a harness, i.e., leading electric wires and a connecting element. The harness and the connecting element limit positions of circuit boards and mechanical elements in the MFP main body.

For example, the connecting element protrudes in the MFP main body (forms a projection in the main body) shown in FIGS. 10 and 10A. Also, the harness and the connecting element are arranged closer to a lower part and a rear surface of the MFP main body, shown in FIG. 11, the harness and the connecting element are arranged on the back of the MFP main body.

Regardless of in which of the positions described above the harness and the connecting element are arranged, connection work is difficult (workability is low). It is difficult to check a connection result (sure connection).

It is possible to connect the MFP and the accessory devices on the outside of an armor cover of the MFP main body using a cable. However, the cable is an obstacle. Further, the cable may be damaged.

### SUMMARY

According to an aspect of the present invention, there is provided an apparatus in which an operation panel is provided from a main body via a column, the apparatus comprising the column located on a side of the main body, wherein the column is hollow and a harness from the main body is located in the column.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a multi-functional peripheral (MFP) and an example of accessory devices integrated with the MFP according to an embodiment of the present invention;

FIG. 2 is a diagram showing the MFP and the accessory devices integrated with the MFP shown in FIG. 1 viewed from the back with a part of a cover removed;

FIG. 2A is a diagram showing the connecter member of the MFP shown in FIGS. 1 and 2;

FIG. 3 is a diagram showing a state in which a part of a chassis of the MFP shown in FIG. 2 is drawn out, i.e., an example of a configuration of a connecting section of a harness housing structure (a column) and the chassis;

FIG. 4 is a diagram showing an example in which the harness housing structure (the column) is integrated with the chassis of the MFP shown in FIG. 3;

FIGS. 5A and 5B are diagrams showing another example in which the harness housing structure (the column) is integrated with the chassis of the MFP shown in FIG. 3;

FIGS. 6A and 6B are diagrams showing still another example in which the harness housing structure (the column) is integrated with the chassis of the MFP shown in FIG. 3;

FIG. 7 is a diagram showing an example in which the chassis of the MFP shown in FIG. 3 is integrated with the harness housing structure (the column);

FIG. 8 is a diagram showing another example in which the chassis of the MFP shown in FIG. 3 is integrated with the harness housing structure (the column);

FIGS. 9A and 9B are diagrams showing an example in which accessory devices attached to the MFP are different from those in the examples shown in FIGS. 3 to 5, 6A, 6B, 7 and 8;

FIGS. 10 and 10A are diagrams showing an example in which the accessory devices and the MFP do not include the harness housing structure shown in FIGS. 3 to 5, 6A, 6B, 7 and 8; and

FIG. 11 is a diagram showing an example of protruding of a cable conspicuous in the accessory devices and the MFP shown in FIGS. 10 and 10A.

### DETAILED DESCRIPTION

An embodiment of the present invention is explained in detail below with reference to the accompanying drawings.

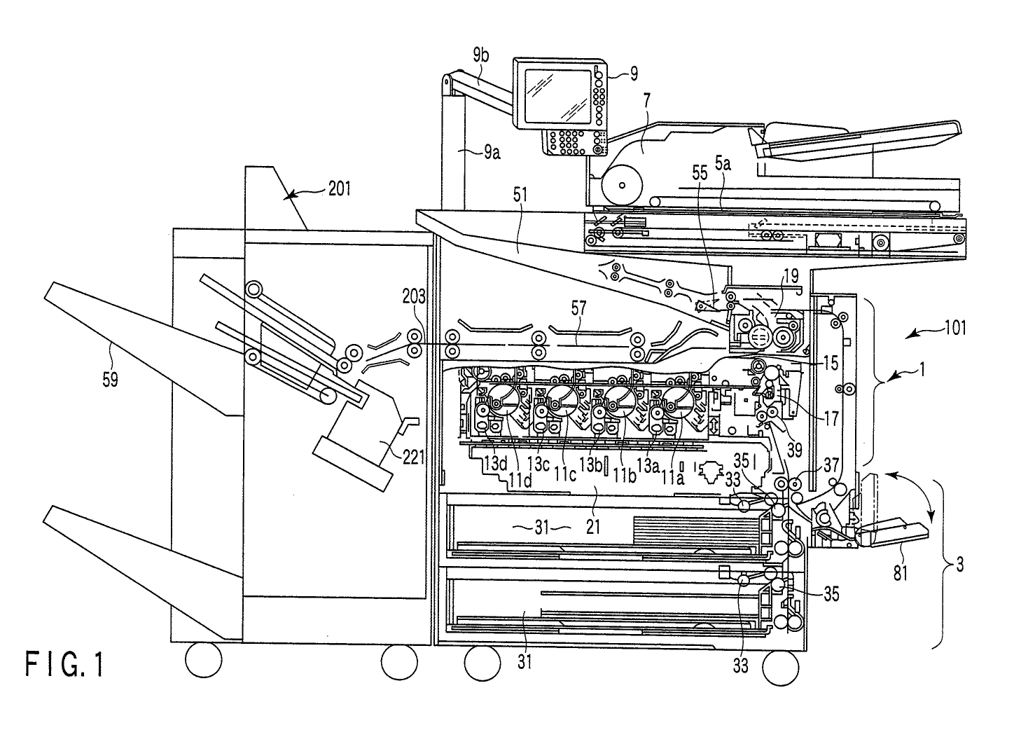

FIG. 1 is a diagram showing a main part of the image forming apparatus according to the embodiment.

An image forming apparatus 101 shown in FIG. 1 includes an image forming unit main body 1 that outputs image information as an output image called, for example, a hardcopy or a printout, a sheet feeding unit 3 that can feed a sheet (an output medium) of an arbitrary size used for image output to the image forming unit main body 1, and an image scanning unit 5 that captures, as image data, image information to be subjected to image formation in the image forming unit main body 1 from an object that holds the image information (hereinafter referred to as original). Although not explained in detail, the image scanning unit 5 includes an original table (original glass) 5a that supports an object and an image sensor that converts image information into image data, for example, a CCD sensor. The image scanning unit 5 converts reflected light obtained by irradiating illumination light from a not-shown lighting device on an original set in the original table 5a into an image signal using the CCD sensor.

The image scanning unit 5 integrally includes an automatic document feeder (ADF) 7 that discharges, when an original is sheet-like, after formation of an image output or capturing (hereinafter referred to as scanning) of image information is finished, the original for which scanning is finished from a scanning position to a discharge position and guides the next original to the scanning position. Although not shown in the figure, it goes without saying that a general original cover (an original press) may be used instead of the ADF 7. The CCD sensor of the image scanning unit 5 is provided in an arbitrary position in a conveying path, on which an original is conveyed, independently from the original table in the ADF 7. Therefore, it is possible to scan image information of an original being conveyed as image data without placing the original on the original table.

An instruction input unit for instructing the start of image formation in the image forming unit main body 1 and the start of scanning of image information of an original by the image scanning unit 5, i.e., a control panel (an operation unit) 9, is arranged in a predetermined position of the image forming apparatus 101, for example, a corner on the left side or the right side behind the image scanning unit 5 or the like via a swing arm 9b arranged in a column 9a (fixed to the image forming apparatus main body 1).

The image forming unit main body 1 includes first to fourth photoconductive drums 11a to 11d that hold latent images, developing devices 13a to 13d that develop latent images formed on photoconductive drums 11a to 11d, a transfer belt 15 that holds, in a stacked state, developer images developed on the photoconductive drums 11a to 11d, a transfer device 17 that transfers the developer images stacked on the transfer belt 15 onto, for example, general plain paper not subjected to special processing or a sheet-like transfer medium (hereinafter referred to as sheet material) such as an OHP sheet as a transparent resin sheet, a fuser device 19 that fixes the developer images, which are transferred onto the sheet material, on the sheet material, and an exposing device 21 that forms latent images on the photoconductive drums 11a to 11d. The first to fourth photoconductive drums 11a to 11d respectively hold electrostatic images (latent images) of colors that should be visualized (developed) by the developing devices 13a to 13d that store toners of arbitrary colors of Y (yellow), M (magenta), C (cyan), and Bk (black). The order of array of the first to fourth photoconductive drums 11a to 11d is defined in predetermined order according to an image forming process and characteristics of toners (developers). The transfer belt 15 holds the developer images of the respective colors formed by the first to fourth photoconductive drums 11a to 11d and the developing devices 13a to 13d corresponding thereto in order of formation of the developer images.

The sheet feeding unit 3 feeds a sheet material used when the transfer device 17 transfers the developer images to the transfer device 17 at predetermined timing.

Cassettes, which are not described in detail, set in plural cassette slots 31 store sheet materials of arbitrary sizes. A pickup roller 33 extracts a sheet material according to an image forming operation not described in detail. A size of the sheet material corresponds to a size of a developer image formed by the image forming unit main body 1. A separating mechanism 35 prevents the pickup roller 33 from extracting two or more sheet materials from the cassettes (separates sheet materials one by one). Plural conveying rollers 37 convey one sheet material limited by the separating mechanism 35 toward an aligning roller 39. The aligning roller 39 feeds, according to timing when the transfer device 17 transfers the developer images from the transfer belt 15, the sheet material to a transfer position where the transfer device 17 and the transfer belt 15 are in contact with each other.

The sheet material on which the developer images corresponding to the image information are fixed via the fuser device 19, i.e., an output image (a hardcopy or a printout) is discharged to a paper discharge tray 51 defined on a side of the image scanning unit 5 and above the image forming unit main body 1. The paper discharge tray 51 is defined in a shape sunk from a space in which a surface including an original surface (an upper surface of the original glass 5a) of the image scanning unit 5 is spread to the image forming unit main body 1 side (below the image scanning unit 5). A switching unit 55 switches a path for the sheet material discharged to the paper discharge tray 51 and a path for the sheet material discharged to the finisher 201.

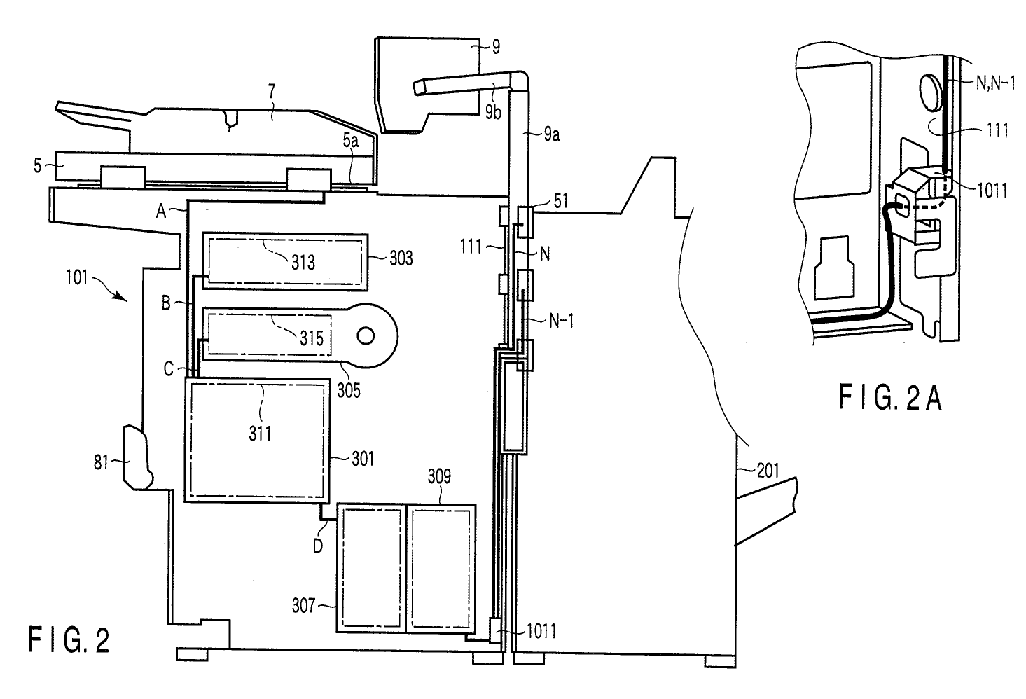

FIG. 2 is a diagram showing the MFP and the accessory devices integrated with the MFP shown in FIG. 1 viewed from the back with a part of a cover removed.

The image forming apparatus 101 includes a group of circuit boards 311, 313, 315, 317, and 319 that control the respective components described above, included in the image forming apparatus main body 1. For example, the circuit board 311 is a main control board including a main control unit. For example, the circuit board 317 is a power supply circuit board that receives electric power from a commercial power supply and supplies necessary DC voltages ±5V and ±24V to the image forming apparatus main body 1. For example, the circuit board 315 is a recording unit that includes a large capacity storage device (HDD) and stores image information scanned by the image scanning unit 5 and various data supplied from the outside through a network and the like. For example, the circuit board 319 includes a communication unit used for connection to the network and exchange of control signals with external devices (accessory devices).

Shield cases 301, 303, 305, 307, and 309 shield the respective circuit boards 311, 313, 315, 317, and 319.

Harnesses A, B, C, . . . , N-1 (N is an integer), and N (N is an integer) electrically connect the respective circuit boards or the accessory devices attached to the image forming apparatus main body 1, i.e., the ADF 7 and the finisher 201. For example, the harness N connects the operation panel 9 and the communication unit (the circuit board 319). For example, the harness N-1 connects the accessory device (the finisher) 201 to the image forming apparatus 101.

FIG. 2A is a diagram showing the connecter holding block holds a connecter member of the MFP (image forming apparatus) shown in FIGS. 1 and 2, for example. In FIG. 2A, the connecter holding block 1011 is positioned inside of the chassis 111 and toward a right side of the chassis 111 of the image forming apparatus 101. Meanwhile, one of the harnesses N or N-1 connects to the accessory device (the finisher) 201 is delivered along the chassis 111.

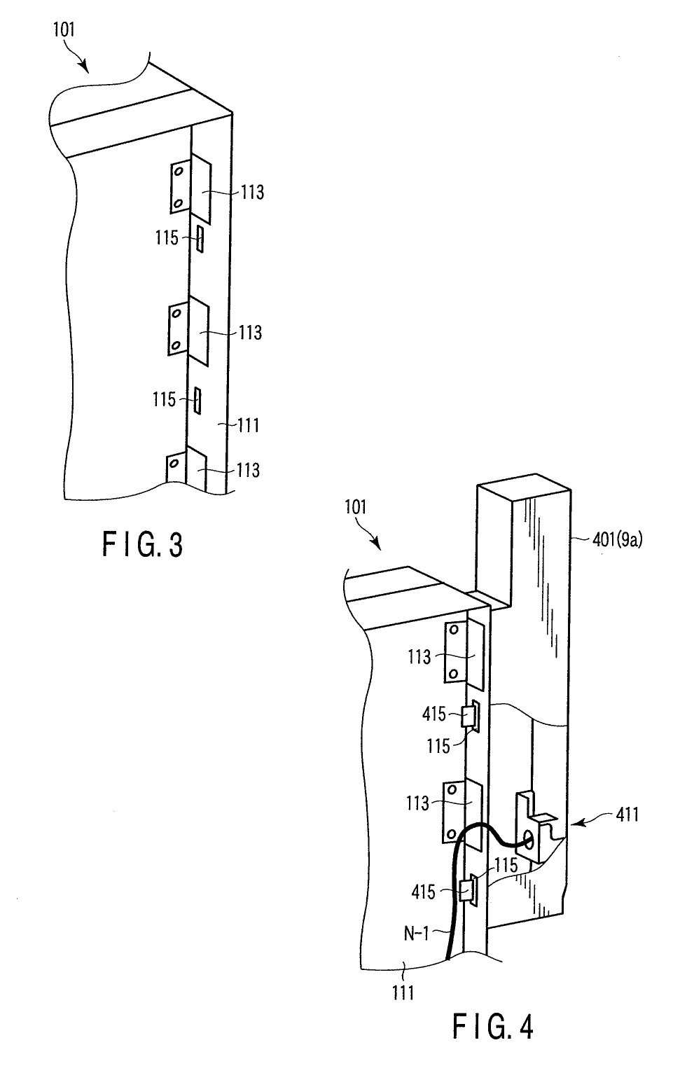

FIG. 3 is a diagram showing a state in which a part of a chassis of the MFP shown in FIG. 2 is drawn out, i.e., an example of a configuration of a connecting section of a harness housing structure (a column) and the chassis.

The chassis 111 of the image forming apparatus 101 includes plural openings 113 and plural slit-like holes (slender openings) 115. The openings 113 allow arbitrary harnesses to pass through the openings 113. Edges sections of the respective openings 113 and 115 include, although not shown in the figure, protective members to prevent the harnesses from being damaged. The respective harnesses may include tubes or protective members formed in a spiral shape.

FIG. 4 is a diagram showing an example in which the harness housing structure (the column) is integrated with the chassis of the MFP shown in FIG. 3.

At least one of the slits 115 of the chassis 111 of the image forming apparatus 101 receives a protrusion 415 that is a part of a column 401 (9a). The column 401 (9a) is integrated with the chassis 111 by using the protrusion 415 (the protrusion 415 is connected to the slit 115). The column 401 (9a) has, in a lower part (lower side) in a height direction, a connection end (a connector holder) 411 that is provided in a harness of an accessory device and to which the harnesses can be connected. For example, although not described in detail, the harness N-1 having a connector provided in advance in the harness N-1 is located in the connector holder 411 (the harness N-1 is connected to the connector holder 411). The column 401 (9a) is hollow and has four sides in a sectional shape, has five or more sides in a sectional shape, or has a section of an arbitrary shape in which circles, ellipses, or free curved surfaces are continuous. A section of the column 401 may be at least partially discontinuous.

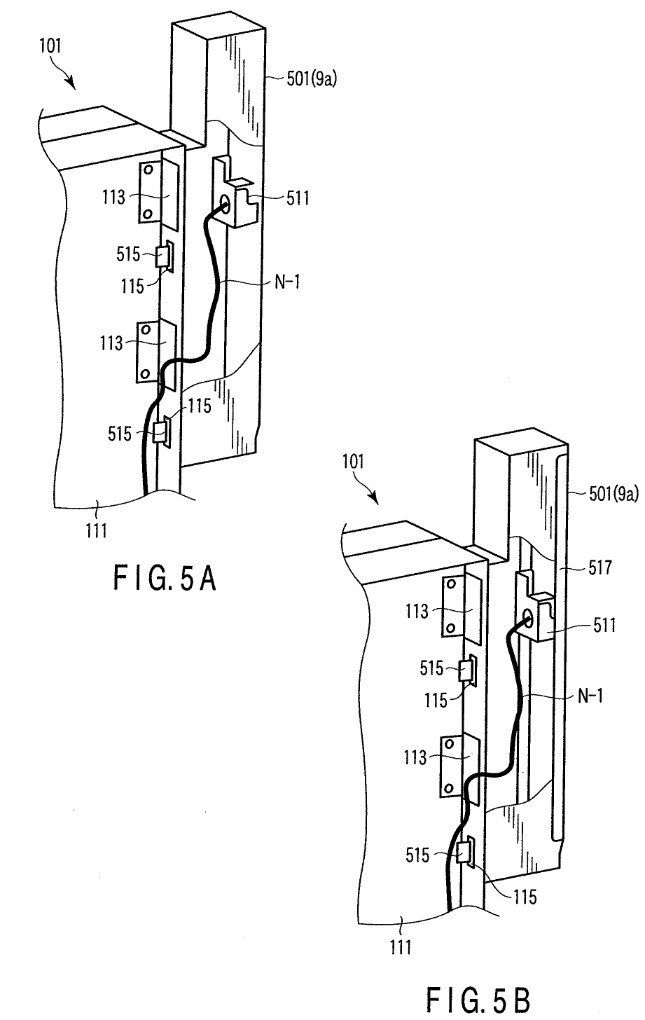

FIGS. 5A and 5B are diagrams showing another example in which the harness housing structure (the column) is integrated with the chassis of the MFP shown in FIG. 3.

At least one of the slits 115 of the chassis 111 of the image forming apparatus 101 receives a protrusion 515 that is a part of a column 501 (9a). The column 501 (9a) is integrated with the chassis 111 by using the protrusion 515 (the protrusion 515 is connected to the slit 115).

The column 501 (9a) has, in an upper part (upper side) in a height direction, a connection end (a connector holder) 511 that is provided in a harness of an accessory device and to which the harnesses can be connected. For example, although not described in detail, the harness N-1 having a connector provided in advance in the harness N-1 is located in the connector holder 511 (the harness N-1 is connected to the connector holder 511). After, a cover 517 covers the harness N-1 and the connection end 511 inside in the column 501 (9a), shown in FIG. 5B.

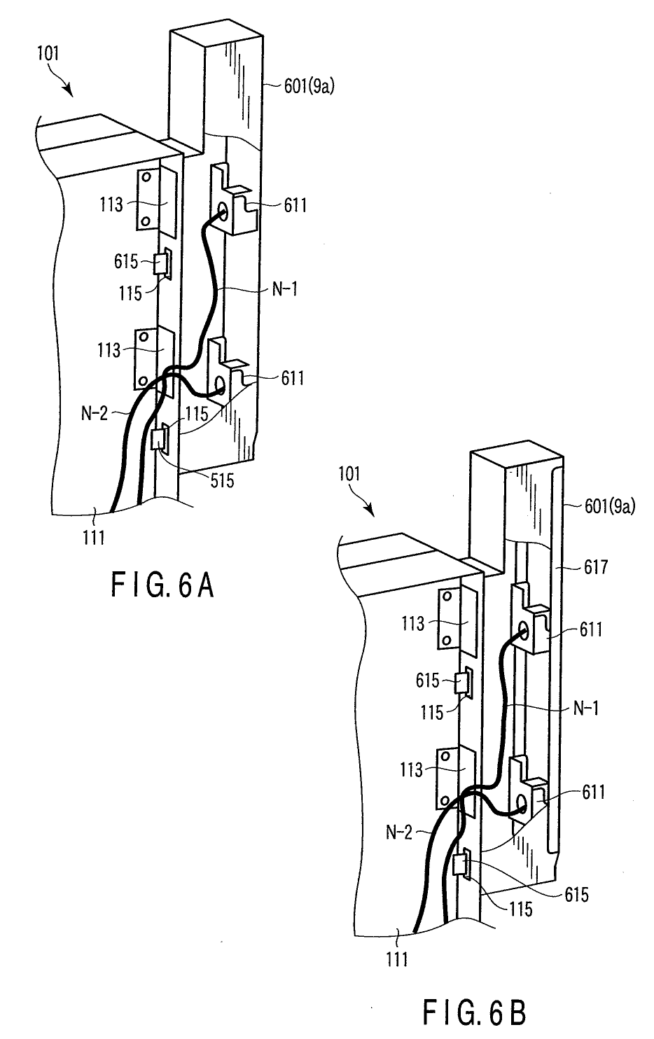

FIGS. 6A and 6B are diagrams showing still another example in which the harness housing structure (the column) is integrated with the chassis of the MFP shown in FIG. 3.

At least one of the slits 115 of the chassis 111 of the image forming apparatus 101 receives a protrusion 615 that is a part of a column 601 (9a). The column 601 (9a) is integrated with the chassis 111 by using the protrusion 615 (the protrusion 615 is connected to the slit 115).

The column 601 (9a) has, in two places spaced apart from each other in a height direction, connection ends (connector holders) 611 that are provided in a harness of an accessory device and to which the harnesses can be connected. For example, although not described in detail, the harness N-1 having a connector provided in advance in the harness N-1 is located in one of the connector holder 611 and the harness N-2 for another accessory device not shown in the figure is located in the other connector holder 611 respectively (the harnesses N-1 and N-2 are connected to the connector holders 611). After, a cover 617 covers the harnesses N-1, N-2 and the connection ends 611 inside in the column 601 (9a), shown in FIG. 6B.

When the columns 401, 501, and 601 shown in FIGS. 4, 5A and 5B, 6A and 6B are integrated with the image forming apparatus 101, the height thereof arbitrarily changes on the basis of the protrusions (415, 515, and 615) connected to the opening 115 of the chassis 111. The columns 401, 501, and 601 shown in FIGS. 4, 5A and 5B, 6A and 6B support the connector holders (411, 511, and 611) in plural positions provided in advance.

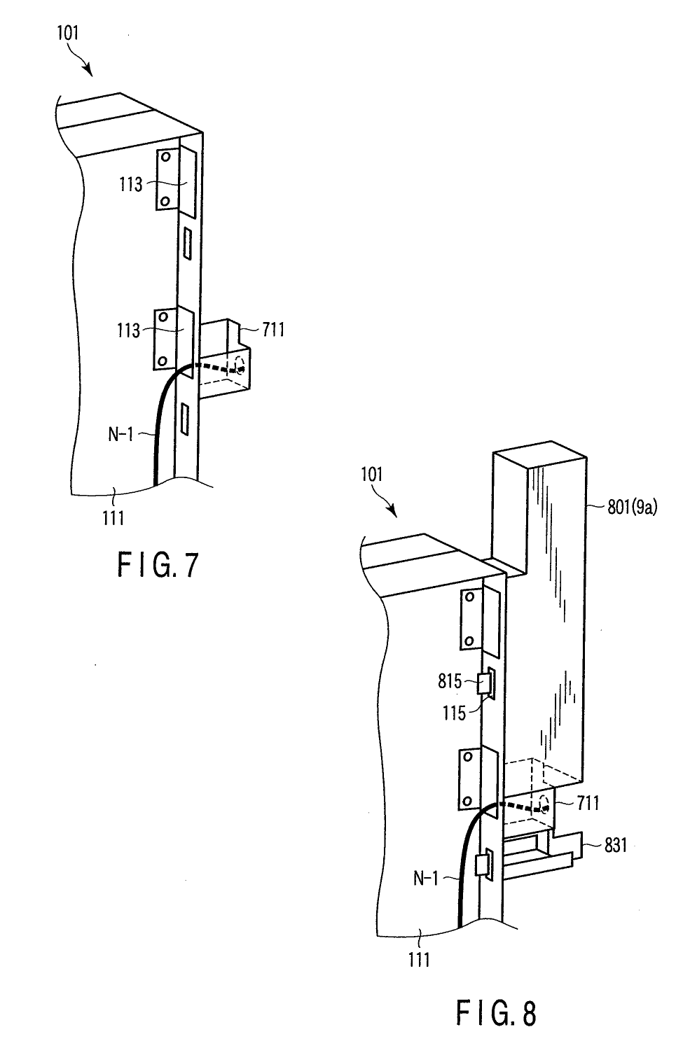

FIGS. 7 and 8 are diagrams showing still other examples in which the harness housing structure (the column) is integrated with the chassis of the MFP shown in FIG. 3.

In the examples shown in FIGS. 4, 5A and 5B, 6A and 6B the connector holders 411, 511, and 611 are integrated with the columns 401, 501, and 601. However, in the example shown in FIG. 7, a connector holder 711 is located in the chassis 111 of the image forming apparatus 101. As shown in FIG. 8, the connector holder 711 is integrated with a reinforcing member 831 provided in advance in the chassis 111 (the connector holder 711 is connected to the reinforcing member 831 integrated with the chassis 111).

As shown in FIG. 8, when the connector holder 711 is integrated with the chassis 111, a column 801 (9a) does not need to be integrated with the connector holder 711. Therefore, cost in manufacturing the column 801 can be reduced.

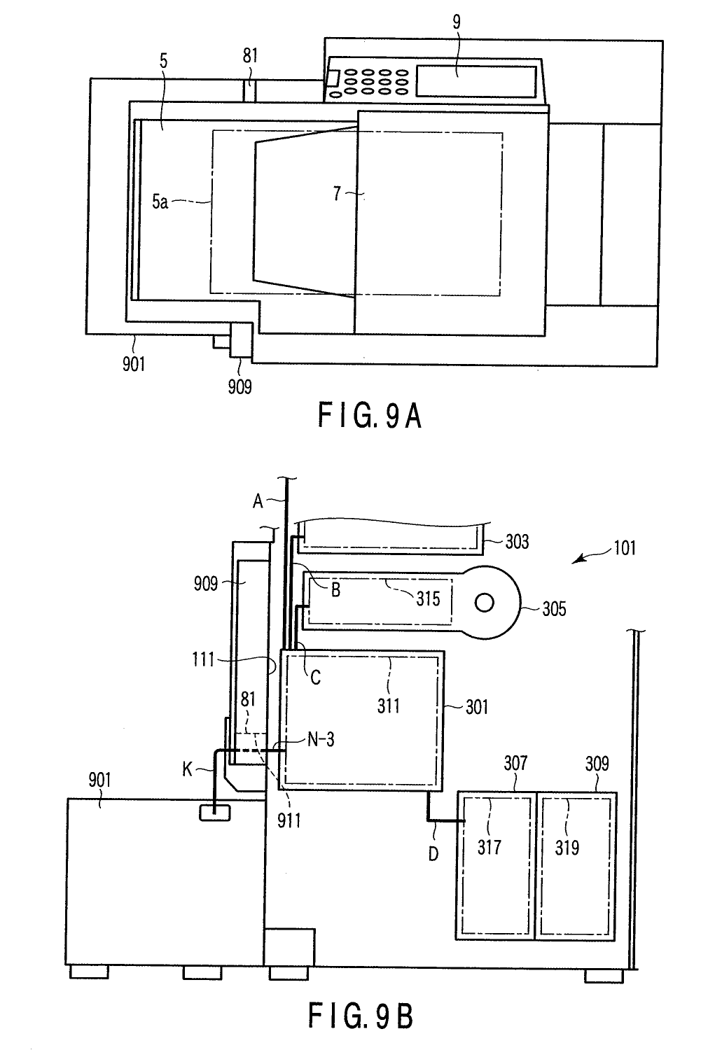

FIGS. 9A and 9B are diagrams showing examples in which accessory devices attached to the MFP are different from those of the examples shown in FIGS. 3, 4, 5A and 5B, 6A and 6B, 7 and 8.

For example, when a large capacity cassette (LCC) 901 is integrated with the image forming apparatus 101, a column 909 is located behind (in the back) of a manual feed tray 81 side. The column 909 is integrated with the chassis 111 of the image forming apparatus 101. The connector holder 911 of the column 909 connects a harness N-3 from the main control circuit board 311 (the shield case 301) and a harness K from the LCC 901.

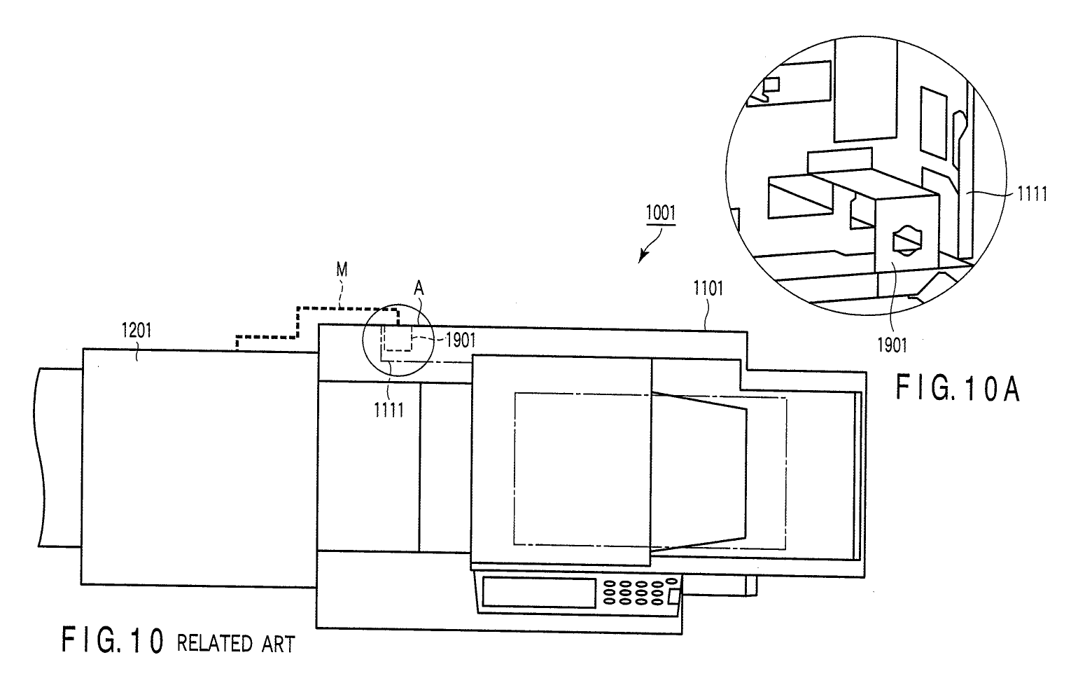

FIGS. 10 and 10A are diagrams showing an example in which harness and the connecting element limit positions of circuit boards and mechanical elements in the MFP main body.

In FIGS. 10 and 10A, in a case that the harness M and the connecting element 1901 are arranged closer to a lower part 1111 and a rear surface 1101 of the MFP main body 1001, the connecting element protrudes in the MFP main body (forms a projection in the main body). The harness connects to an accessory 1201 and the MFP main body is an obstacle and may be damaged.

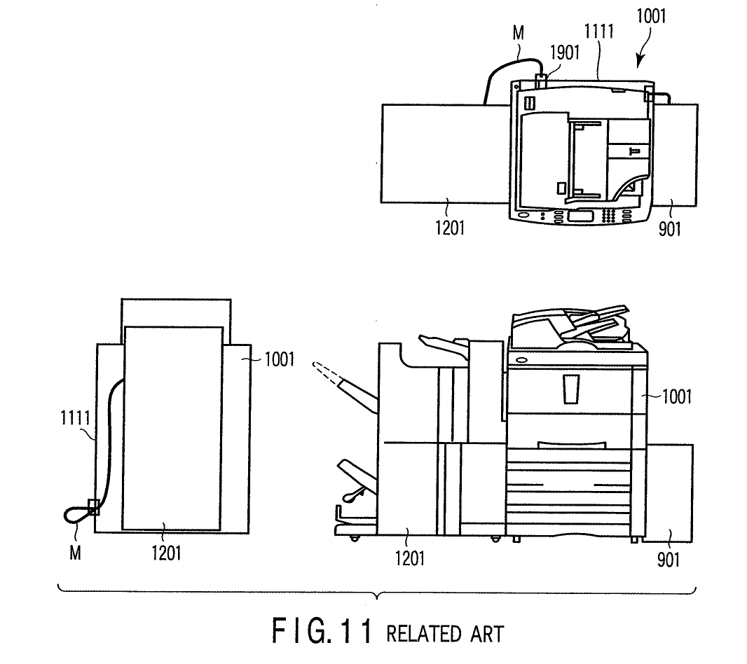

FIG. 11 is a diagram showing an example of protruding of a cable conspicuous in the accessory devices and the MFP main body.

In the example shown in FIG. 11, the harness (the cable) M protrudes exceeding a back level of the image forming apparatus 1001 and the finisher 1201. In other words, the cable (the harness) M is an obstacle. Further, the cable M may be damaged.

As explained above, the image forming apparatus and the accessory devices according to the embodiment of the present invention can suppress the harness and the connecting element integrated with the accessory devices and the MFP main body from limiting positions of the circuit boards and the mechanical elements in the MFP main body.

The image forming apparatus and the accessory devices according to the embodiment of the present invention suppress the arrangement of the harness and the connecting element integrated with the accessory devices and the MFP main body from limiting positions of the circuit boards and the mechanical elements in the MFP main body.

The image forming apparatus and the accessory devices according to the embodiment of the present invention that make it easy to check connection of the harness and the connecting element integrated with the accessory devices and the MFP main body and a connection result.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
an operation panel;
the column is hollow; and
a harness from the main body is located in the column.

2. The apparatus of claim 1, further comprising:
a connector held in the column.

3. The apparatus of claim 2, wherein the column holds the connectors in plural positions.

4. The apparatus of claim 2, wherein the column is located in a different position on the side of the main body.

5. The apparatus of claim 2, wherein the column is connected to a connector provided on the main body side.

6. An image forming apparatus comprising:
an image forming unit that outputs an image corresponding to image data to an output medium;
a fuser unit that fixes the image outputted from the image forming unit on the output medium;
a chassis structure that houses the image forming unit and the fuser unit;
a circuit board that actuates at least the image forming unit and the fuser unit, controls operations of at least the image forming unit and the fuser unit, and outputs a control signal used for guiding the output medium, on which the image is fixed by the fuser unit, to a device attached to the image forming apparatus; and
a harness housing structure that houses a harness member, which transmits a signal between a circuit board and the device attached to the image forming apparatus, independently from the chassis structure and supports a connector connected to a cable from the attached device.

7. The apparatus of claim 6, wherein the harness housing structure holds the connector.

8. The apparatus of claim 6, wherein the harness housing structure holds the connector in plural positions.

9. The apparatus of claim 6, wherein the harness housing structure is located in a different position in the chassis structure.

10. The apparatus of claim 6, wherein the harness housing structure is connected to a connector provided in the chassis structure.

11. The apparatus of claim 10, further comprising an operation input unit that is located in a holding structure including the harness housing structure and with which instructions for controlling image formation by the image forming unit and output of an output medium to the attached device are inputted.

12. The apparatus of claim 11, wherein the harness housing structure holds plural connectors.

13. The apparatus of claim 11, wherein the harness housing structure holds the connector in plural positions.

14. The apparatus of claim 11, wherein the harness housing structure is located in a different position in the chassis structure.

15. The apparatus of claim 11, wherein the harness housing structure is connected to a connector provided in the chassis structure.

16. The apparatus of claim 11, further comprising an image scanning unit that obtains image information for the image forming unit to output an output image.

17. The apparatus of claim 16, wherein the harness housing structure holds a plurality of the connectors.

18. The apparatus of claim 16, wherein the harness housing structure holds the connector in plural positions.

19. The apparatus of claim 16, wherein the harness housing structure is located in a different position (height) in the chassis structure.

20. The apparatus of claim 16, wherein the harness housing structure is connected to a connector provided in the chassis structure.

21. The apparatus of claim 6, wherein the fuser unit is located below the image scanning unit and on a side of the image forming unit.

22. The apparatus of claim 21, wherein the operation input unit is located in a space on a side of the image scanning unit and above relatively an output position of the output medium outputted by the fuser unit.

23. The apparatus of claim 21, wherein the harness housing structure holds a plurality of the connectors.

24. The apparatus of claim 21, wherein the harness housing structure holds the connector in plural positions.

25. The apparatus of claim 21, wherein the harness housing structure is located in a different position (height) in the chassis structure.

26. The apparatus of claim 21, wherein the harness housing structure is connected to a connector provided in the chassis structure.
